(19) United States
(12) Patent Application Publication
(10) Pub. No.: US 2015/0291448 A1
(43) Pub. Date: Oct. 15, 2015

(54) Reverse Osmosis System For Supplying Purified Water

(71) Applicant: Benjamin J. Koppenhoefer, Ft. Lauderdale, FL (US)

(72) Inventor: Benjamin J. Koppenhoefer, Ft. Lauderdale, FL (US)

(21) Appl. No.: 14/253,039

(22) Filed: Apr. 15, 2014

(51) Int. Cl. C02F 1/44; B01D 63/00

(52) U.S. Cl. CPC C02F 1/441; B01D 63/00; C02F 2101/10

(57) ABSTRACT

A water purification system includes a first reverse osmosis device, and a water storage tank including a tank inlet and a tank outlet, the tank inlet configured to receive a permeate of the first reverse osmosis device. The system also includes a second reverse osmosis device including an inlet that is connected to the tank outlet and an outlet that releases a permeate of the second reverse osmosis device. The system provides treated water having a purity of about 0 to 20 ppm, which is sufficiently pure to provide spot-free washing and/or rinsing of objects such as vehicles, buildings and windows.

### FIELD OF THE INVENTION

This invention relates in general to a reverse osmosis system to supply purified water for a spot free rinsing system, particularly for vehicles, motorcycles, vessels, aircraft, buildings, windows, and other substantial objects.

### BACKGROUND OF THE INVENTION

Fresh water usually contains impurities, minerals and other dissolved solids. When used in a washing system, such impure water will leave water stains or spots on the washed objects, such as vehicles, motorcycles, vessels, buildings, and windows. Although some conventional washing systems include drying devices that are employed after a final rinse, such drying devices consume large amounts of electrical energy.

An alternative solution is to use purified water in the rinsing system to avoid “spotting”. Some washing systems employ water-softening methods that mainly rely on the removal of Ca²⁺and Mg²⁺from a solution or the sequestration of these ions. A water-softening system usually uses ion-exchange resins containing sodium ions (Na⁺) that are readily replaced by hardness ions such as Ca²⁺and Mg²⁺. However, water-softening rinsing systems often possess drawbacks which reduce their effectiveness. One drawback is that they may reduce only Ca²⁺and Mg²⁺from a solution, and leave other total dissolved solids (TDSs) in water. Another drawback is that periodically the ion-exchange resins must be regenerated, and will gradually become exhausted and must be replaced.

In another approach, output from a reverse osmosis device may be used for washing objects such as vehicles. The reverse osmosis device includes a housing that is configured to be pressurized, and a semi-permeable membrane that is supported within the housing. In the reverse osmosis device, a fluid solution (e.g., the feed solution) is passed through a semi-permeable membrane that is selected to remove undesired molecules and ions. An applied pressure is used to overcome the natural flow of a solvent from an area of low solute concentration to an area of high solute concentration, thus reversing osmosis through the semi-permeable membrane. The result is that the concentrated solute, referred to herein as “the concentrate,” is retained on the pressurized side of the semi-permeable membrane and a purified solvent, referred to herein as the “permeate,” is allowed to pass to the other side of the semi-permeable membrane. When used to treat water, a reverse osmosis device can in some cases remove 96%-99% of TDSs and 100% of hardness from the water.

### SUMMARY

In the water purification system, a two-pass reverse osmosis treatment of the feed water may be performed, in which the permeate output of a first reverse osmosis device is used as the feed solution of a second reverse osmosis device. The two-pass treatment provides water of sufficient purity (e.g., having TDS in a range of 0 to 20 ppm) to provide a substantially spot-free wash and/or rinse of an object. This is advantageous for washing and/or rinsing sea going vessels such as yachts which typically have unlimited access to sea water. Although single-pass desalinating reverse osmosis devices are commonly found on yachts, a single-pass treatment will remove about 99 percent of TDS from sea water, which has about 32,000 ppm of TDS. Unfortunately, the single-pass treatment, which provides a permeate having about 320 ppm of TDS, does not provide water that is sufficiently pure to provide a substantially spot-free wash and/or rinse.

In the water purification system, a water storage tank is disposed in the flow path that joins the output of the first reverse osmosis device to the input of the second reverse osmosis device, whereby the second reverse osmosis device receives water from the tank as its input source. Having the water storage tank intermediate the first and second reverse osmosis devices provides the following advantages: Since the tank receives and stores the permeate from the first reverse osmosis device, there is no longer a requirement to exactly match the output characteristics (e.g., flow rate, flow volume, etc.) from the first reverse osmosis device to the supply requirements of the second reverse osmosis device, whereby a two-pass reverse osmosis treatment of water can be obtained from two different types of reverse osmosis devices. This is particularly advantageous for use on sea going vessels which may include a pre-existing desalinating reverse osmosis device that provides a single-pass treatment of sea water. The existing system can be easily and inexpensively retro-fitted to include a second pass purification capability by providing the second reverse osmosis device and the intermediate tank, without concerns as to whether the individual reverse osmosis devices are compatible for use in a direct serial arrangement. For example, the water purification system including the water storage tank allows for the feed of desalinated permeate water from a desalination reverse osmosis system to a fresh water system without interrupting the flow which could cause damage to desalination system or to the desalination systems plumbing and/or components.

In addition, since the storage tank can receive water from both the first reverse osmosis device and from other sources, for example a fresh water source, the water purification system can receive and treat feed water from multiple sources simply and inexpensively. The water purification system can be used in different modes purifying feed water from the multiple sources in a variety of ways. For example, the first reverse osmosis device can be used alone to treat only sea water, providing treated water having a moderate amount of TDSs. Alternatively, the first reverse osmosis device can be used in combination with the second reverse osmosis device to treat only sea water to provide treated water having very low TDSs. In another alternative mode, the first reverse osmosis device can be used in combination with the second reverse osmosis device to treat both sea water and water from a second source such as a fresh-water source to provide water having very low TDSs. In still another alternative mode, the second reverse osmosis device can be used alone to treat water received from the second source such as a fresh-water source to provide water having very low TDSs.

Further advantageously, the water storage tank can be physically arranged relative to the second reverse osmosis device in a manner that provides a gravity feed of the feed solution to the second reverse osmosis device. This feature reduces the size, complexity and cost of the second reverse osmosis device since a fluid pump is no longer required for drawing in the feed solution and/or producing sufficient pressure within the device to achieve reverse osmosis through the semi-permeable membrane.

### BRIEF DESCRIPTION OF THE FIGURES

FIG. 1 is a schematic view of a water purification system including a first reverse osmosis device, a second reverse osmosis device configured to receive the permeate of the first reverse osmosis device as an input, and a water storage tank disposed intermediate the permeate output of the first osmosis device and the input of the second reverse osmosis device.

FIG. 2 is a schematic view of an alternative water purification system including a reverse osmosis device configured to receive the output of a water storage tank as an input, where the tank is configured to be connected to a permeate output of a pre-existing reverse osmosis device.

### DESCRIPTION OF THE INVENTION

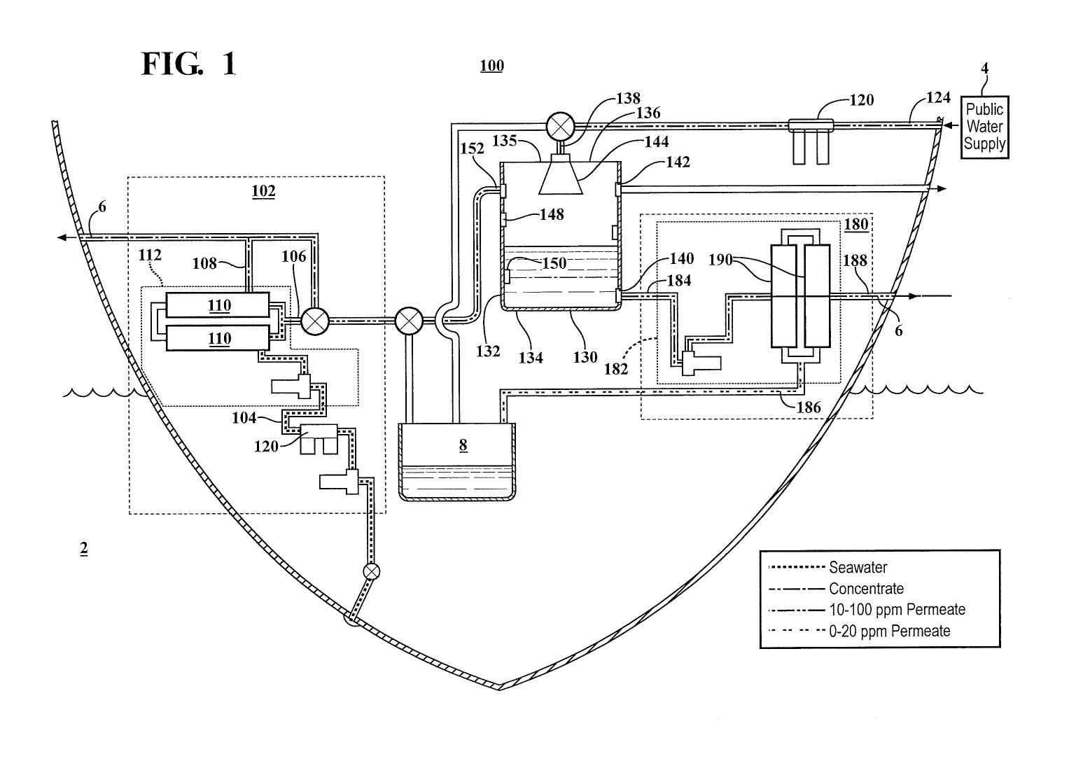

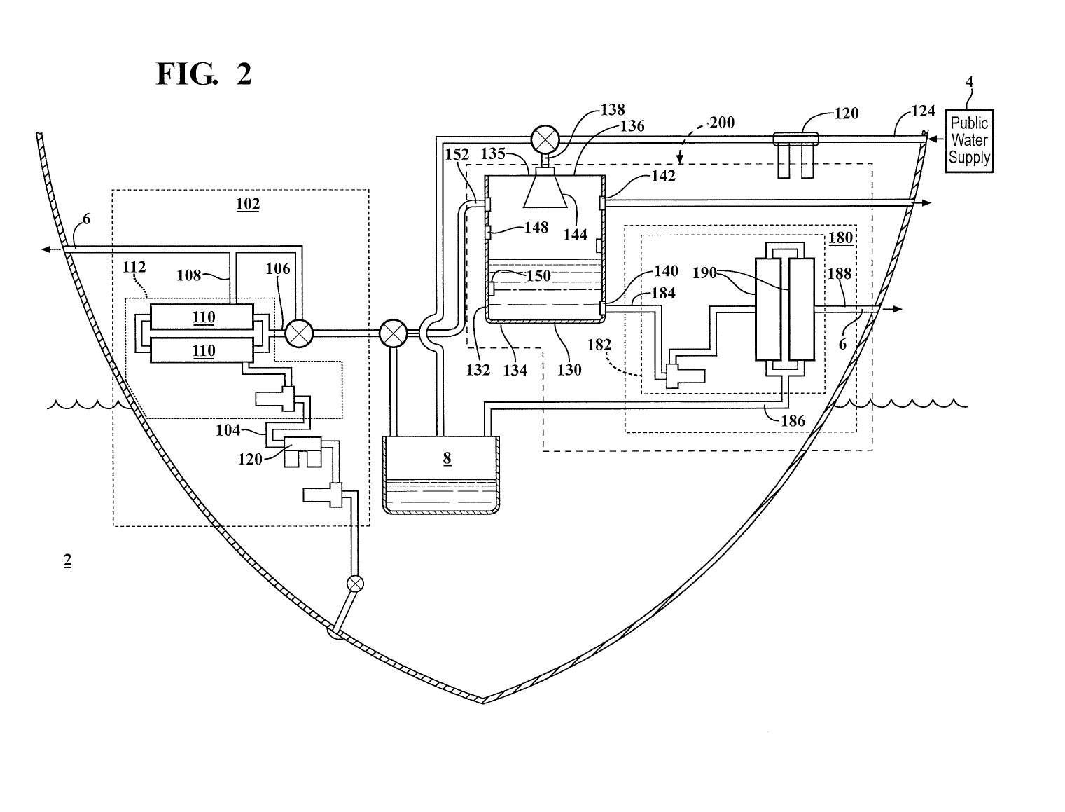

Referring to FIGS. 1 and 2, a water purification system 100 employs reverse osmosis to supply treated water having sufficient purity (e.g., having TDS in a range of 0 to 20 ppm) to provide spot free rinsing of a seagoing vessel such as a yacht. Generally, the water purification system 100 is a series arrangement of a first reverse osmosis device 102 and a second reverse osmosis device 180 that provides a two-pass purification in which the permeate output of the first reverse osmosis device 102 is further purified by the second reverse osmosis device 180. In the water purification system 100, a water storage tank 130 is disposed in the flow path that delivers the permeate output of the first reverse osmosis device 102 to input of the second reverse osmosis device 180. As a result, the second reverse osmosis device 180 receives output from the tank 130 as its feed solution, as discussed in detail below.

The first reverse osmosis device 102 includes a housing 112 that is configured to be pressurized, and a semi-permeable membrane 110 that is supported within the housing 112. The housing 112 includes an input 104 that can be connected to a fluid source 2. The housing 112 includes a first output 106 disposed on a down-stream side of the semi-permeable membrane 110, the first output 106 providing the permeate output. The housing 112 also includes a second output 108 disposed on an up-stream side of the semi-permeable membrane, the second output 108 providing the concentrate output. In this embodiment, the first reverse osmosis device 102 is a desalinating reverse osmosis device and the fluid source 2 is seawater having about 32,000 ppm of TDS. A portion of the input seawater is forced through the semi-permeable membrane 110, and this permeate exits the first reverse osmosis device 102 as treated water via the first output 106. The remaining input seawater does not pass through the semi-permeable membrane and becomes concentrated with the molecules and ions removed from the permeate. This concentrate exits the first reverse osmosis device 102 via the second output 108, and is disposed of, for example, by sending it to a drain 6.

The water storage tank 130 includes sidewalls 132, a closed bottom 134, and an open upper end 135. The upper end 135 is selectively closed by a detachable cover 136 that permits access to the tank's interior space for maintenance. The tank 130 includes two inlets 138, 152 that receive feed water, and an outlet 140. Inlet 138 can be connected to the public water supply 4, or to another source. Inlet 152 is connected to the output 106 of the desalination system 102. Inlet 152 is unrestricted as to not cause pressure build up which could damage hoses, fittings, or the desalination system itself. As a safety feature, the tank 130 also includes a mechanical float valve 144 disposed near the upper end 135 that detects when the tank 130 is at the maximum fill level, and automatically stops flow into the tank 130 via the inlet 138 when the tank 130 is full. The tank 130 also includes a first electrical sensor 148 located near the upper end 135 that detects whether the tank 130 is at a maximum fill level, and a second electrical sensor 150 located near the bottom 134 that detects whether the tank 130 is at a minimum fill level. The first and second electrical sensors 148, 150 are used to control operation of the second reverse osmosis device 180, as discussed further below.

The interior space of the tank 130 is maintained at atmospheric pressure via a vent 142 disposed above the maximum fill level. The water storage tank 130 has a volume in a range of about 1-10 gallons, and is separate from and smaller the main water storage tank 8 of the yacht, which may have a volume in a range of about 25 gallons to 300 gallons. Note that in FIG. 1 the illustrated sizes of the water storage tanks 130, 8 are disproportionate and not to scale.

As previously discussed, the water storage tank 130 receives and stores the permeate output from the first reverse osmosis device 102 via inlet 152. The duration of storage may be brief, e.g., consisting of the time required to flow into and immediately out of the tank 130, or may be extended, e.g., a period of days or weeks. In addition to receiving the permeate of the first reverse osmosis device 102, the tank 130 is also configured to receive and store fluid from a second fluid source. In the illustrated embodiment, a line 124 is configured to connect a fresh water source 4 to the tank inlet 138, regulated by the mechanical float valve 144. In the illustrated embodiment, the fresh water source 4 is a potable, public water supply accessed via a conventional tap, but the water source 4 is not limited to this source.

The line 124 includes a pre-filtration unit 120 used to pre-filter the fresh water before it reaches the tank 130. The pre-filtration unit 120 includes a pressure vessel containing one or more pre-filtration cartridges, and is capable of removing suspended solids, chlorine, chloramines, organics, iron, and other contaminants from the water. For example, commercially available 1 micron sediment filter can be used to remove suspended solids and sediment having a size larger than 1 microns. In addition, commercially available media KDF 55 can be used to reduce chlorine, iron, hydrogen sulfide, heavy metals, and bacteria from water. Granulated Activated Carbon (GAC) can be used to remove chlorine, chloramines, and other contaminates. If all three media are used, water may flow, for example, from 1 micron sediment, to KDF 55, and then to GAC.

The second reverse osmosis device 180 includes a housing 182 that is configured to be pressurized, and a semi-permeable membrane 190 that is supported within the housing 182. The housing 182 includes an input 184 that is connected to the outlet 140 of the tank 130. The housing 182 includes a first output 186 disposed on a down-stream side of the semi-permeable membrane 190, the first output 186 providing the permeate output. The housing 182 also includes a second output 188 disposed on an up-stream side of the semi-permeable membrane 190, the second output 188 providing the concentrate output. The source of the feed solution supplied to the input 184 is the contents of the tank 130, which, in this embodiment, includes treated water output from the first reverse osmosis device 102, fresh water obtained from the conventional public water supply 4, or a mixture of the two. A portion of the feed solution is forced through the semi-permeable membrane 190, and this permeate exits the second reverse osmosis device 180 as treated water via the first output 186. The permeate from the second reverse osmosis device 180 may be used immediately, or may be stored for future use in the main water storage tank 8 of the yacht or in another storage device (not shown). The remaining feed solution does not pass through the semi-permeable membrane 190 and becomes concentrated with the molecules and ions removed from the permeate. This concentrate exits the second reverse osmosis device 180 via the second output 188, and is disposed of, for example, by sending it to a drain 6.

The second reverse osmosis device 180 operates based on detected fluid levels within the tank 130. In particular, when the first electrical sensor 148 detects that the tank 130 is at a maximum fill level, the second reverse osmosis device 180 begins fluid treatment, and continues fluid treatment until the second electrical sensor 150 detects that the tank 130 is at a minimum fill level.

The tank 130 and the second reverse osmosis device 180 are positioned relative to each other so that the output of the tank 130 is gravity fed to the second reverse osmosis device 180. In particular, the tank 130 is positioned at a location that is above the second reverse osmosis device 180. This arrangement reduces the size, complexity and cost of the second reverse osmosis device 180 since a fluid pump is not required for drawing in the feed solution and/or producing sufficient pressure within the device to achieve reverse osmosis through the semi-permeable membrane 190.

The feed solution input into the second reverse osmosis device 180 via the input 184 will generally have moderate to low levels of impurity, but is not of sufficient purity to provide spot-free washing and/or rinsing. For example, if the source of the feed solution is the treated water output from the first reverse osmosis device 102, the feed solution will have about 320 ppm of TDS. If the source of the feed solution is fresh water from the public water supply 4, the feed solution will have about 800 ppm TDS or less. After treatment of the feed solution, the second reverse osmosis device 180 provides a permeate having a purity of about 0 to 20 ppm, which is sufficiently pure to provide spot-free washing and/or rinsing.

As an illustrative example, the water purification system can be used to provide purified water for use in washing and rinsing sea-going vessels such as yachts. When off-shore, single-pass reverse osmosis desalination systems are conventionally used to purify seawater to provide potable water. Such systems typically take in normal sea water having about 32,000 ppm of TDS, and reduce the TDS in the sea water by about 99 percent, producing a permeate having approximately 320 ppm of TDS. However, this level of purification is not sufficient to provide a spot-free wash or rinse. Similarly, when docked or on-shore, yacht owners have access to tap water (fresh water), which is typically below 800 ppm of TDS. Although such fresh water may be potable, it may still contain sufficient TDS to prevent spot-free washing and/or rinsing. In this case, a single-pass reverse osmosis treatment of the water from the fresh-water source may provide excellent results, e.g. a permeate having less than 20 ppm of TDS. However, due to differing water sources (e.g., sea water and fresh water) and resulting reverse osmosis device feed requirements (i.e., pressure, flow rate, etc.) for the differing water sources, it can be challenging and expensive to connect the reverse osmosis device used to purify the fresh water directly to an output of a desalinating reverse osmosis device in a traditional “double-pass” configuration.

The water purification system 1 disclosed herein provides sufficiently high purity (e.g., less than 20 ppm) for spot free vessel washing and/or rinsing while accommodating the multiple-types of feed water used in a sea-going vessel. This is accomplished by providing the water storage tank 130 intermediate the first, or desalinating, reverse osmosis device 102 and the second reverse osmosis device 180, whereby there is no need to provide pressure or flow-rate matching between the first and second reverse osmosis devices 102, 180. The second reverse osmosis device 180 is operated when there is a predetermined water level within the tank 130. In addition, the second reverse osmosis device 180 is gravity fed from the tank 130, where by the second reverse osmosis device 180 may be pump free.

Referring to FIG. 3, in some aspects, an alternative water purification system 200 may comprise a tank 230 and a reverse osmosis device 280 connected to an output of the tank 230, where the tank 230 and reverse osmosis device 280 correspond to the tank 130 and second reverse osmosis device 180 described above with respect to FIG. 2. The alternative water purification system 200 differs from the previously described water purification system 100 in that the first reverse osmosis device 102 is omitted. The alternative water purification system 200 can be used in conjunction with (e.g., connected to an output of) a pre-existing reverse osmosis system 202 to provide enhanced water purification. This is particularly beneficial for use in yachts and other seagoing vessels that include desalinating reverse osmosis devices as standard equipment.

The design of the feed of the water storage tank 130 prevents overfilling of the tank 130 by providing two layers of over-fill protection while not interrupting desalinated permeate water flow. The water storage tank 130 includes the mechanical float valve 144 that allows water into the tank 130 when the valve float is not elevated by water to the “full” level. If the mechanical float valve 144 is closed with the first reverse osmosis device 102 operating and producing permeate water, the water will be discharged via a safety vent overboard fitting to the drain 6 to prevent back pressure on the first reverse osmosis device 102. In addition, check valves are used to prevent back flow into first reverse osmosis device 102, the fresh water supply 4, and drains 6.

The water storage tank 130 may be wall mounted or may be free-standing. In addition, the tank 130 may be designed so that critical components can be mounted directly on to it for convenience as well as functionality. In some examples, an operating and control panel of the second reverse osmosis device 180 may be mounted directly onto the tank. Since the panel contains the pump for the reverse osmosis process, the water can be gravity-fed into the reverse osmosis pump instead of needing an auxiliary booster pump to supply second reverse osmosis device 180. Also, since the tank 130 can serve as a mounting bracket, the water purification system 100 is not modular, saving installation time. This can be compared to some prior systems in which modular components are each mounted in the sea-going vessel separately and then plumbed and wired together by an installer. With the water purification system 100, including the water storage tank 100, the components 102, 130, 180 can be assembled and wired together before the installation.

The water purification system 100 is advantageous relative to some fresh water reverse osmosis systems that relied on city tap pressure to supply adequate water to the pump. This may be problematic when sea-going vessels travel to locations around the world with poor tap water pressure, since low tap water pressure can cause the reverse osmosis system to be inoperable and un-usable while the user was located in those geographic areas. By including the water storage tank 130, the water purification system 100 does not rely on tap water pressure to supply system pump as the pump remains flooded from gravity feed.

Although the water purification system is described herein with respect to its utility on a yacht, it is understood that it is not limited to this application, and can be used to provide spot-free washing and/or rinsing of other objects including automobiles, trucks, motorcycles, aircraft, buildings, and windows.

In the illustrated embodiments, the tank 130 is positioned at a location that is above the second reverse osmosis device 180 to permit gravity feed of the second reverse osmosis device. However, the water purification system is not limited to this physical arrangement, and a pump may be provided to ensure proper fluid flow through the second reverse osmosis device when necessary.

Selected illustrative embodiments of the water purification system are described above in some detail. It should be understood that only structures considered necessary for clarifying the water purification system have been described herein. Other conventional structures, and those of ancillary and auxiliary components of the system, are assumed to be known and understood by those skilled in the art. Moreover, while working examples of the water purification system have been described above, the present invention is not limited to the working examples described above, but various design alterations may be carried out without departing from the present invention as set forth in the claims.

What is claimed is:

1. A water purification system comprising:
a first reverse osmosis device;
a water storage tank including a tank inlet and a tank outlet, the tank inlet configured to receive a permeate of the first reverse osmosis device; and
a second reverse osmosis device including an inlet that is connected to the tank outlet and an outlet that releases a permeate of the second reverse osmosis device.

2. The water purification system of claim 1, wherein the water storage tank is configured to receive fluid from a second fluid source in addition to receiving fluid from the first reverse osmosis device.

3. The water purification system of claim 2, wherein the first reverse osmosis device is configured to desalinate sea water and the second fluid source is fresh water.

4. The water purification system of claim 1, wherein the tank is arranged relative to the second reverse osmosis device such that fluid flowing between the tank outlet and the inlet of the second reverse osmosis device is gravity fed.

5. The water purification system of claim 1, wherein the tank comprises an air vent.

6. The water purification system of claim 1, wherein the tank comprises
an electronic fill level detector;
a tank inlet that is unrestricted to prevent back pressure damage, and
a mechanical float valve that is configured to control fluid flow through the tank inlet based on a position of a float relative to the tank.

7. The water purification system of claim 1 wherein the tank comprises
a first electronic fill level detector configured to detect a full state of the tank; and
a second electronic fill level detector configured to detect an empty state of the tank, wherein the second reverse osmosis device is configured to begin operating based on a signal from the first electronic fill level detector and stops operating based on an output signal from the second electronic fill level detector.

8. The water purification system of claim 1 wherein the tank comprises a first electronic fill level detector configured to detect a full state of the tank;
a second electronic fill level detector configured to detect an empty state of the tank;
a tank inlet that is unrestricted to prevent back pressure damage; and
a mechanical float valve that is configured to control fluid flow through the tank inlet based on a position of a float relative to the tank.
wherein the second reverse osmosis device is configured to begin operating based on an output signal from the first electronic fill level detector and stops operating based on an output signal from the second electronic fill level detector.

9. The water purification system of claim 1 further comprising filters disposed in the second line at a location between the second fluid source and the tank inlet.

10. The water purification system of claim 1 wherein the second reverse osmosis device is boost pump free.

11. A water purification system comprising:
a water storage tank including a tank inlet and a tank outlet; and
a system reverse osmosis device including a device inlet that is connected to the tank outlet and a device outlet that releases a permeate of the reverse osmosis device resulting from a reverse osmosis treatment of fluid stored in the tank, wherein
the tank inlet is configured to be connected to an output of a desalinating reverse osmosis device, and to a second fluid source that is independent of the desalinating reverse osmosis device.

12. The water purification system of claim 11, further comprising the desalinating reverse osmosis device.

13. The water purification system of claim 11, wherein the system reverse osmosis device is boost pump-free and is arrange relative to the tank so as to be gravity fed.

14. The water purification system of claim 11, wherein the tank comprises a vent that communicates with the atmosphere.

15. The water purification system of claim 11, wherein the tank comprises
an electronic fill level detector;
a tank inlet that is unrestricted to prevent back pressure damage; and
a mechanical float valve that is configured to control fluid flow through the tank inlet based on a position of a float relative to the tank.

16. The water purification system of claim 11 wherein the tank comprises
a first electronic fill level detector configured to detect a full state of the tank; and
a second electronic fill level detector configured to detect an empty state of the tank, wherein the system reverse osmosis device begins operating based on a signal from the first electronic fill level detector and stops operating based on an output signal from the second electronic fill level detector.

17. The water purification system of claim 11 wherein the tank comprises
a first electronic fill level detector configured to detect a full state of the tank;
a second electronic fill level detector configured to detect an empty state of the tank;
a tank inlet that is unrestricted to prevent back pressure damage; and
a mechanical float valve that is configured to control fluid flow through the tank inlet based on a position of a float relative to the tank.
wherein the system reverse osmosis device begins operating based on an output signal from the first electronic fill level detector and stops operating based on an output signal from the second electronic fill level detector.

18. The water purification system of claim 11 further comprising filters disposed in a fluid line that connects the second fluid source and the tank inlet.

19. The water purification system of claim 11 wherein the system reverse osmosis device is booster pump free.
